(19) United States
(12) Patent Application Publication
(10) Pub. No.: US 2007/0041706 A1
(43) Pub. Date: Feb. 22, 2007

(54) Systems and methods for generating multimedia highlight content

(75) Inventor: Priyan Gunatilake, San Diego, CA (US)

Correspondence Address: CROWELL & MORING LLP;INTELLECTUAL PROPERTY GROUP, P.O. BOX 14300, WASHINGTON, DC, 20044-4300, US

(73) Assignees: Sony Corporation; Sony Electronics, Inc.

(21) Appl. No.: 11/199,635

(22) Filed: Aug. 9, 2005

(51) Int. Cl. H04N 7/00

(52) U.S. Cl. 386/95

(57) ABSTRACT

User-defined parameters and/or default parameters are used to detect the presence of potential highlights within a recorded version of a full-length broadcast program, according to one embodiment. Locations within the recorded program which satisfy any of the user or default parameters may then be added to a highlight list, which is usable to generate a highlight program. In one embodiment, video packets, audio packets and closed-caption packets are parceled out from the video stream and analyzed separately. For each of the types of packets analyzed, the locations and descriptions of potential highlights may be tabulated. This tabulated data may then be correlated and consolidated into a single highlight list which is usable to access the various identified highlights from the recorded full-length broadcast program, and to present them in sequence on a display device.

### FIELD OF THE INVENTION

The invention relates in general to multimedia highlight content, and in particular, to generating multimedia highlight content from a full-length multimedia broadcast presentation.

### BACKGROUND OF THE INVENTION

The personal video recorder (PVR) and digital video recorder (DVR) have become increasingly popular devices in today's age of digital media. More than ever, consumers are appreciating the value in being able to time shift broadcast content. In addition, the ability to skip advertisements and navigate recorded content has generally been well received by consumers.

Despite the advantages offered by DVR technology, broadcast programs can often be large and cumbersome to navigate. This is particularly true for lengthy sports programming. This is why there is a significant amount of television programming devoted to sports highlights. The problem with such highlight content is that is currently being created manually using non-linear editing systems by media editors. Media editors are able to use their subjective judgment to key material in a full-length program and assemble it into a highlights program. This is of course a very laborious process which largely substitutes the subjectivity of the media editors for the individual viewers'.

Thus, there is still an unsatisfied need for a system and method for generating multimedia highlight content in an automatic fashion based on one or more user-defined parameters.

### SUMMARY OF THE INVENTION

Systems and methods for generating multimedia highlight content are disclosed and claimed herein. In one embodiment, a method includes receiving one or more user highlight parameters, parceling Multimedia content into video packets and closed-caption packets where the video packets include a plurality of frames, and processing the video packets to identify graphical changes within a predetermined frame location between two or more frames. In one embodiment, the graphical changes are indicative of a potential highlight segment. The method further includes processing the closed-caption packets to identify highlight keywords that match at least one of the user highlight parameters, and compiling a plurality of potential highlight segments into a highlight program based on one of the identified graphical changes and the identified highlight keywords.

Other embodiments are disclosed and claimed herein.

### BRIEF DESCRIPTION OF THE DRAWINGS

FIG. 1 is a block diagram of a DVR capable of implementing one or more aspect of one embodiment of the invention;

FIG. 2 is a simplified block diagram showing inputs and outputs to and from a multimedia highlight engine capable of implementing one or more aspect of one embodiment of the invention;

FIG. 3 depicts a simplified block diagram of one embodiment of the multimedia highlight engine of FIG. 2;

FIG. 4 depicts a simplified block diagram of one embodiment of the pre-processor of FIG. 3;

FIG. 5 is a diagram of one embodiment of the highlight extractor of FIG. 3, including the inputs and outputs thereto;

FIG. 6 is a diagram of one embodiment of the highlight consolidator of FIG. 3, including the inputs and outputs thereto;

FIG. 7 depicts a functional diagram of the editing and playback functionality of one embodiment of the invention;

FIG. 8 depicts one embodiment of a graphical user interface for interacting with and/or implementing one or more aspects of the invention; and

FIGS. 9A-9D depict conceptual diagrams of the highlight program creation process.

### DETAILED DESCRIPTION OF THE EXEMPLARY EMBODIMENTS

The invention relates to a system and method for generating multimedia highlight content based on a recorded full-length broadcast program. In one embodiment, one or more user-defined parameters and/or default parameters are used to detect the presence of a potential highlight within a recorded version of the full-length broadcast program. Locations within the recorded program which satisfy any of the user or default parameters may then be added to a highlight list, which is usable to generate a highlight program.

One aspect of the invention is to provide an algorithm set which operates on the video content to identify potential highlights, as defined by user and/or default parameters. In one embodiment, a user may provide one or more keywords particular to the type of highlight desired. In another embodiment, a default set of keywords may be used instead of or in addition to user-defined keywords.

Another aspect of the invention is to parcel out the video packets, audio packets and closed-caption packets from a multimedia stream. Once separated, particular frames (e.g., I-frames) within the video packets may be analyzed for changes indicative of a potential highlight. Closed-caption packets may also be analyzed for the occurrence of keywords which match default or user-defined keywords. Similarly, the audio packets may be analyzed for speech containing highlight-indicative keywords.

Still another aspect of the invention is to tabulate the locations and descriptions potential highlights within the full-length broadcast program. In one embodiment, a video list containing the locations and descriptions of potential highlights identified by video analysis is generated. Similarly, an audio list and/or closed-caption list may be generated where each contains the locations and descriptions of potential highlights identified by speech recognition and closed-caption text analysis, respectively. In one embodiment, these three list are correlated and compiled into a single highlight list. The highlight list may then be used to access the various identified highlights from the recorded full-length broadcast program, and to present them in sequence on a display device.

Another aspect of the invention is to enable a user to edit and customize the various identified highlights to create a final highlight “program.” While in one embodiment, the customized highlight program may be stored separately on a local storage device, in another embodiment, the resulting highlight program may be generated “on the fly” by successively accessing the identified highlights in the recorded content and displaying them on a display device as if it were a separately existing program.

When implemented in software, the elements of the invention are essentially the code segments to perform the necessary tasks. The program or code segments can be stored in a processor readable medium or transmitted by a computer data signal embodied in a carrier wave over a transmission medium or communication link.

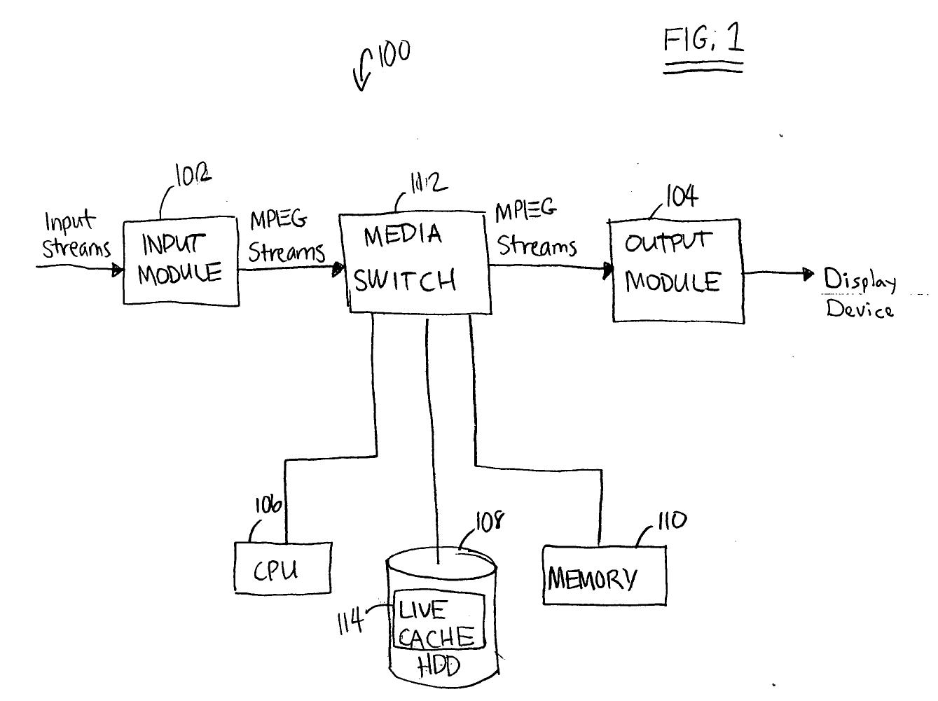

Referring now to the figures, FIG. 1 illustrates an embodiment of a DVR system 100 capable of implementing one or more aspects of the invention. In the embodiment of FIG. 1, the system 100 includes an input module 102, a media switch 112, and an output module 104. In one embodiment, the input module 102 may accept video input streams in a multitude of forms (e.g., National Television Standards Committee (NTSC), PAL, Digital Satellite System (DSS), Digital Broadcast System (DBS), Advanced Television Standards Committee (ATSC), etc.). DBS, DSS, and ATSC are based on standards called Moving Pictures Experts Group 2 (MPEG2) and MPEG2 Transport. However, it should equally be appreciated that the input module 102 may accept video input streams having any other protocol (e.g., AVCIMPEG4). Similarly, while portions of the following discussion refer to only MPEG streams and programs, it should equally be appreciated that MPEG2, MPEG4, AVC content, etc. is also intended to be covered.

The input module 102 provides a media stream to the media switch 112. The input module 102 may also be used to tune the channel to a particular program, extract a specific MPEG program out of it, and feed it into the rest of the system. Analog video signals may be encoded into a similar MPEG format using separate video and audio encoders, such that the remainder of the system is unaware of how the signal was obtained. Information may be modulated into the Vertical Blanking Interval (VBI) of the analog video signal in a number of standard ways. For example, the North American Broadcast Teletext Standard (NABTS) may be used to modulate information onto lines 10 through 20 of an NTSC signal, while the FCC mandates the use of line 21 for Closed Caption (CC) and Extended Data Services (EDS). Such signals may be decoded by the input module 102 and passed to the other modules as if they were delivered via a private data channel.

In one embodiment, the media switch 112 mediates between a microprocessor CPU 106, hard disk or other storage device 108, which may or may not include the DVR system's live cache 114, and volatile memory 110. Input streams are converted to an MPEG stream and sent to the media switch 112. The media switch 112 buffers the MPEG stream into memory. If the user is watching real time broadcast content, the media switch 112 may send the stream to the output module 104, as well as simultaneously write it to the hard disk or storage device 108.

The output module 104 may take the MPEG streams as input and produces an analog video signal according to a particular standard (e.g., NTSC, PAL, or other video standard). In one embodiment, the output module 104 contains an MPEG decoder, on-screen display (OSD) generator, analog video encoder and audio logic. The OSD generator may be used to supply images which will be overlaid on top of the resulting analog video signal. Additionally, the output module 104 can modulate information supplied by the program logic onto the VBI of the output signal in a number of standard formats, including NABTS, CC, and EDS.

Memory 110 may further contain instructions to cause CPU 106 to insert programming information directly into the MPEG data stream(s). The user may input control instructions for displaying such programming information via button a remote control device, for example. It should equally be appreciated that a user may provide instructions to the DVR system 100 using any other known user input means. As will be described in more detail below, memory 110 may also include one or more instructions for generating multimedia highlight content based on broadcast content received by the input module 102.

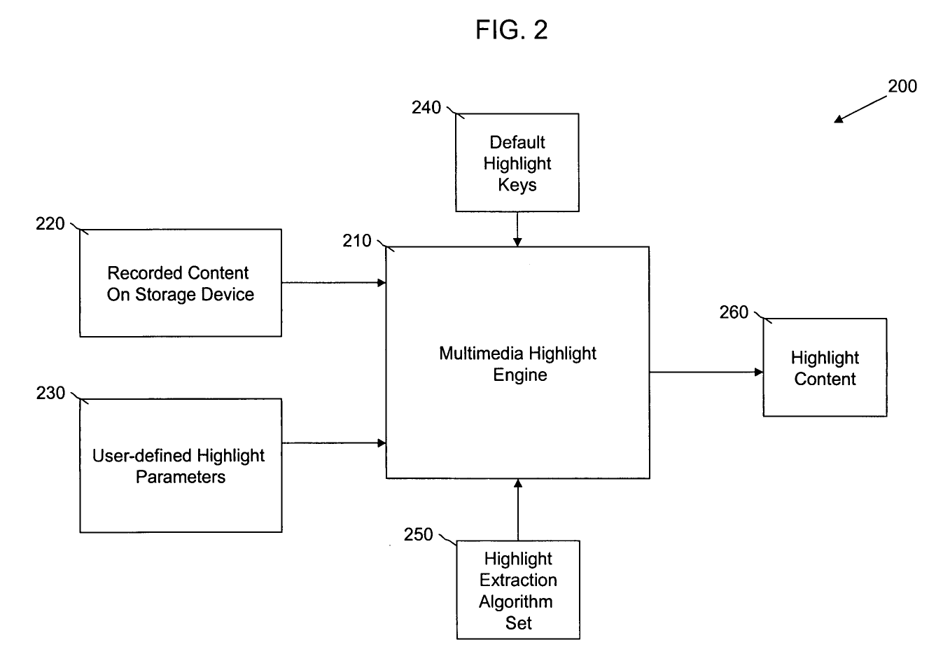

FIG. 2 depicts a simplified block diagram of a system 100 which includes various inputs and outputs to and from a multimedia highlight engine (MHE) 210 capable of implementing one or more aspect of one embodiment of the invention. In the embodiment of FIG. 2, recorded content 220 is provided to the MHE 210 from a client-side storage device (e.g., storage device 108). In addition, one or more user-defined highlight parameters 230 may also be provided to the MHE 210. In one embodiment, the user-defined highlight parameters 230 include keywords identifying particular individuals, actions or events which the user deems highlight worthy. For example, in the case of a sporting event, the parameters 230 may include score changes, turnovers, coach interviews, player interviews, Jerome Bettis (player) highlights, etc. By entering one or more keywords, the user can define any event, person, thing or action to constitute a highlight.

In other embodiment, user-defined parameters 230 may be provided for financial programming content. In this case, users can define particular companies, currencies, fund managers, etc. to be highlight worthy. Similarly, user-defined parameters 230 may be provided for news programming to key in on particular countries, states, world leaders, world events, local news events, etc. It should be appreciated that the variety of possible user-defined parameters 230 is limitless, as is the type of programming which can be used to create highlights in accordance with the invention. Moreover, the parameters 230 may be provided by a user using any number of input devices, such as keyboards, remote controls, etc.

In addition to the recorded content 220 and user parameters 230, the MHE 210 may also make use of one or more default highlight parameters 240 based on the type of programming being processed. For example, in the case of a baseball game, any homerun may be considered a default highlight even though the user has not specifically added a user parameter 230 for homeruns. Similarly, any score change in a football game may be considered a highlight and, as such, a default highlight key 240 for score changes may be provided to the MHE 210.

Continuing to refer to FIG. 2, another input into the MHE 210 is the highlight extraction algorithm set 250. In one embodiment, this algorithm set 250 is a collection of algorithms which operate on the video data (e.g., recorded content 220). As will be described in more detail below, the algorithm set 250 is a set of logic which monitors the incoming video stream for changes at specific locations within the video, specifics words within the audio, or specific text in the closed caption portion of the transmission. In one embodiment, the algorithm set 250 operates on the recorded content 220 based on the user-defined parameters 230 and/or the default parameters 240.

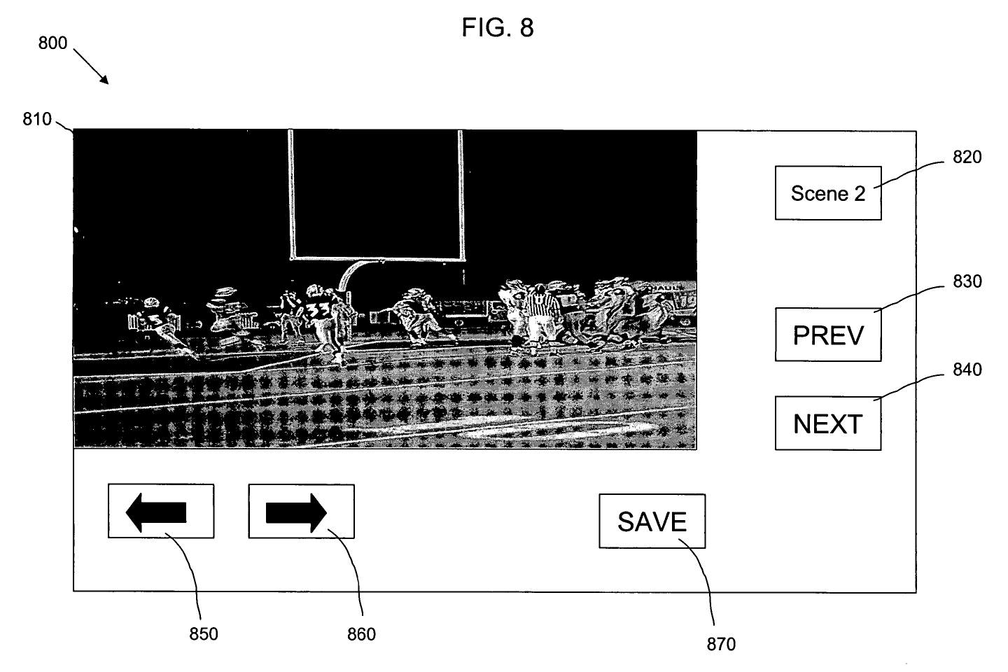

The output from the MHE 210 is highlight content 260. In one embodiment, highlight content 260 is comprised on a plurality of individual media segments selected from the recorded content 220 based on their probability of being a highlight, as either defined by the user or by the default settings. As will be described in more detail below with reference to FIG. 8, once created the highlight content 260 may be edited and further customized by the user using a graphical user interface.

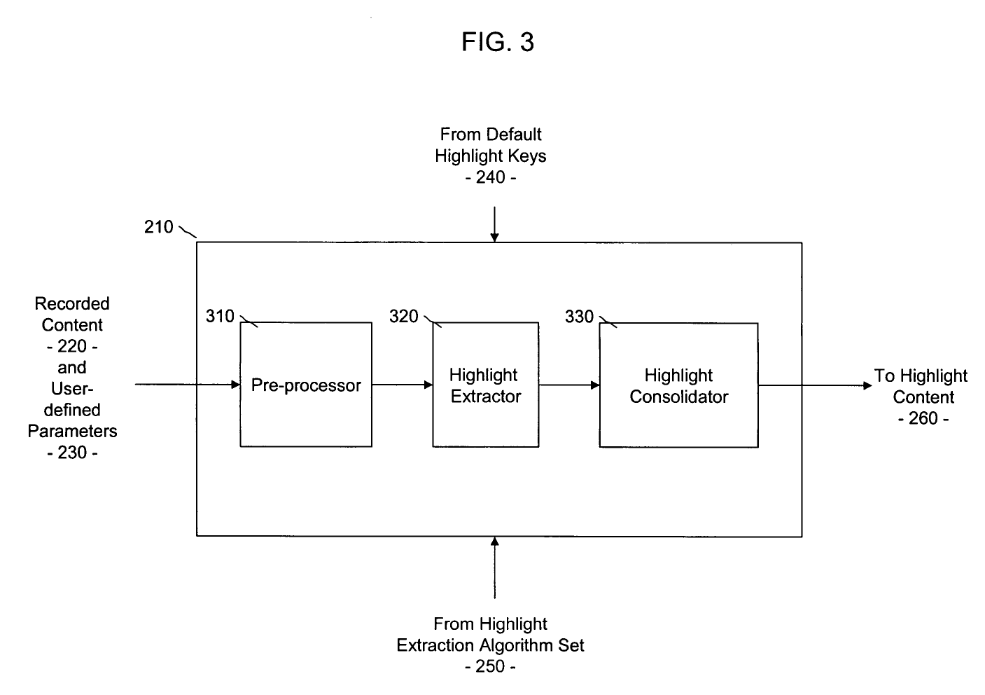

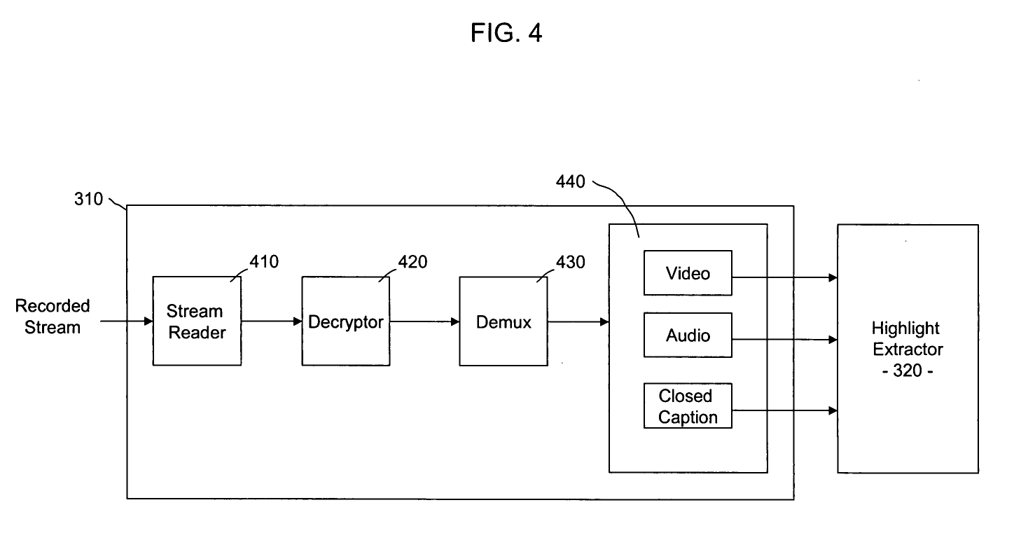

FIG. 3 illustrates a more detailed diagram of the MHE 210 of FIG. 2. In this embodiment, the MHE 210 is comprised of a pre-processor 310, a highlight extractor 320 and a highlight consolidator 330. Each of the MHE 210 components are described below with reference to FIGS. 4-6.

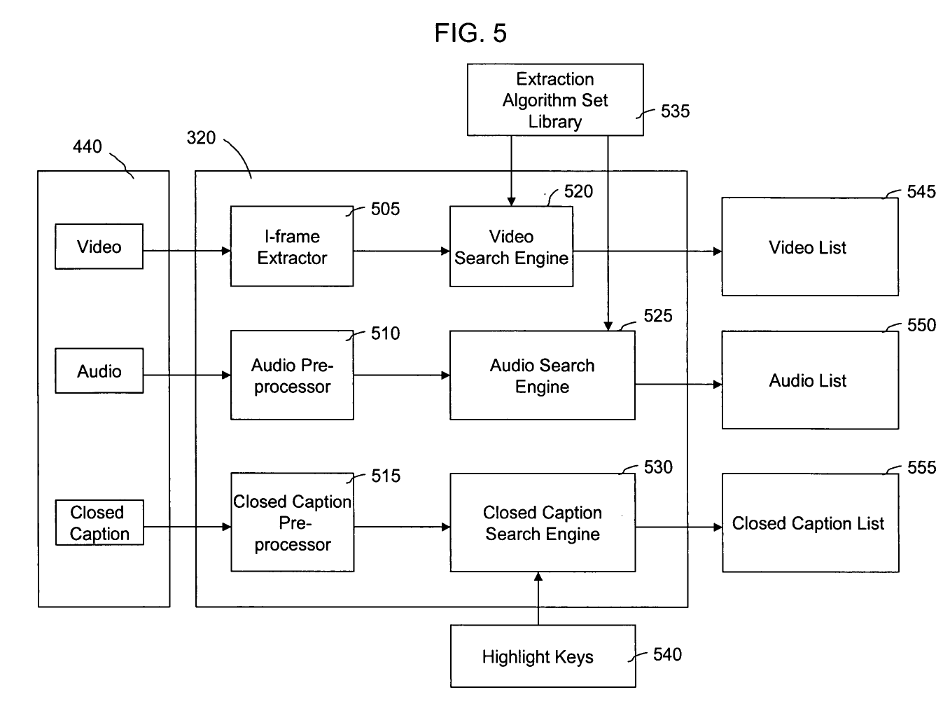

FIG. 4 is a more detailed block diagram of the pre-processor 310 of FIG. 3. In this embodiment, pre-processor 310 includes a stream reader 410 which reads the stream from the storage media and determines its encryption state. If encrypted, such as an MPEG2 or AVC stream, the stream may then be provided to decryptor 420 for decrypting the media content. Once decrypted, demux 430 may be used to separate the stream into a collection of video packets, audio packets and closed-caption packets, which may then be stored in buffer 440. Buffer 440 can then provide the separated data to the highlight extractor 320, which will now be described with reference to FIG. 5.

FIG. 5 is a block diagram of one embodiment of the highlight extractor 320 of FIG. 3. In this embodiment, buffer 440 feeds video packet data, audio packet data and closed-caption data into the extractor 320. With respect the video packet data, an I-frame extractor 505 is used to extract out the Independent frames (I-frames) from the video stream. While extracting out only I-frames may be more efficient, it should equally be appreciated that other frame data may also be used. In still another embodiment, only every n-th I-frame is extracted from the video stream.

Once extracted, the frame data may be passed to the video search engine 520. Using the algorithm set library 535 (which is comprised of the highlight algorithm set 250, the video search engine 520 compares the video or text at a given coordinate of the frame for two successive frames. This comparison is performed to detect a change indicative of a potential highlight. For example, in the case of a sports broadcast, the top-right corner of the frame may contain a score box. By analyzing successive frames, the video search engine 520 can detect changes in the area of the screen, thereby indicating a score change. Assuming that score changes are either a default highlight or a user-defined highlight, this location within the program may then be identified as a highlight and this information may then be tabulated in a video list 545. In one embodiment, the video list is a table of potential highlight locations and their descriptions (e.g., type of highlight).

Continuing to refer to the video packet processing, it should equally be appreciated that changes in the video stream may be detected using other frame comparisons, and not necessarily a comparison of successive frames. In addition, sports broadcast score boxes often contain other information, such as which team is in possession of the ball, which bases have a man on, etc. Thus, changes in any of the data provided graphically, can be detected and used to identify a potential highlight. In the case of financial programming, for example, a stock ticker can be analyzed to detect when a particular stock symbol comes up. Similarly, many news programs have graphical text at the bottom of the screen detailing the topic of discussion. This area can be analyzed by the video search engine 520 to identify a particular word or graphic based on the previously provided user parameters 230 and/or default keys 240.

Referring now to the audio processing portion of the highlight extractor, FIG. 5 indicates that the audio packets are provided from buffer 440 to an audio pre-processor 510. In one embodiment, the audio pre-processor 510 us usable to decode the audio signal to generate one or more audio samples. These audio samples may then be provided to an audio search engine 525 which is charged with identifying the existence of particular words which indicate the presence of a potential highlight. As with the video search engine 520, the audio search engine 525 can use the highlight algorithm set library 535 to search for and identify audio data which satisfies either the previously-provided user parameters 230 and/or default keys 240. Once the audio search engine 525 has identified a potential highlight, this location within the program may then be identified as a highlight and tabulated as such an audio list 550. The audio list 550, like the video list 545, may be a table of potential highlight locations and their descriptions (e.g., type of highlight). In one embodiment, the audio search engine 525 functions as a voice or speech recognition engine.

Continuing to refer to FIG. 5, the last form of data packets to be processed by the highlight extractor 320 are closed-caption packets. As with the audio and video packets, the closed-caption packets are provided by the buffer 440 to a pre-processor 515. Once the text contained in the closed-caption packets has been decoded and processed by the pre-processor 515, it is provided to the closed-caption search engine 530. Highlight keys 540 are then used by the search engine 530 to search through the closed caption text for particular keywords which indicate the existence of a potential highlight. In one embodiment, the highlight keys 540 may be comprised of the user-defined parameters 230 and/or the default highlight keys 240. Once the closed-caption search engine 530 locates a highlight keyword, the location and highlight description may be tabulated in a closed-caption list 555.

In addition to identifying the occurrence of a keyword in the closed caption and audio feeds, in another embodiment context logic can be used to filter out false positives. For example, in a baseball game an announcer may use the word “homerun” despite the fact that a homerun had not been scored. One way to filter out such false positives is to perform a context analysis of how the keyword was used. For example, a predetermined number of words before and after the keyword may be analyzed. If the word “needs” appears in the same sentence before the word “homerun,” this is likely to be a false positive. On the other hand, if the words “just hit” appears before the word “homerun,” this is more likely to be an actual score change highlight. Another way to filter out potential false positives is to cross-reference against the graphical score change, as detected by the video search engine 520.

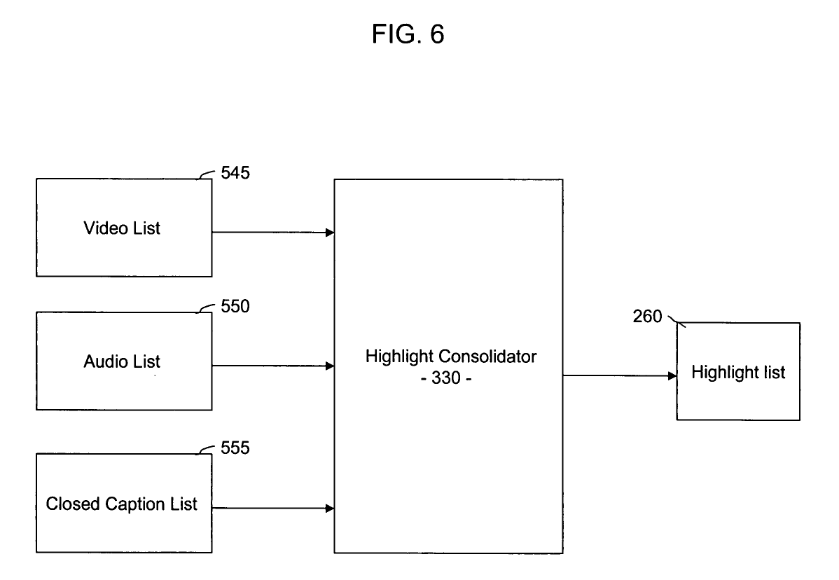

Referring now to FIG. 6, depicted is a simplified block diagram of a highlight consolidator 330 of FIG. 3. In one embodiment, the function of the highlight consolidator 330 is to correlate the information in the video list 545, audio list 550, and closed-caption list 555. That is, entries of potential highlights in one or more of the lists 545, 550 and 555 are compared and cross referenced to identify the location and type of highlight. For example, suppose there is a video list 545 entry described as a “score change” at 1:11:05. In addition, suppose there is a closed-caption list 555 entry described as a “touchdown” at 1:11:35. In this case, these entries would be consolidated and used to populate the highlight list 260 for the touchdown highlight. In this fashion, information from all three lists can be consolidated into a single highlight list with a timestamp and highlight description.

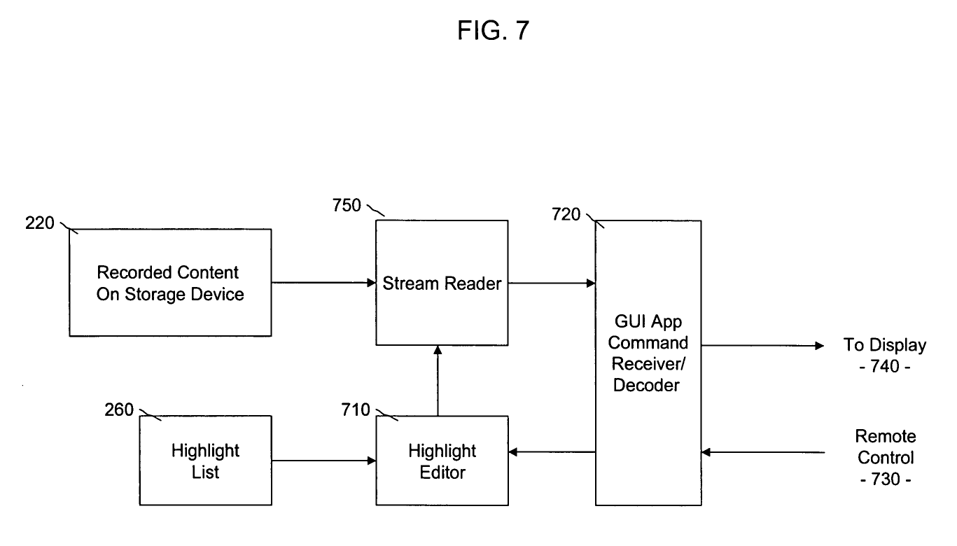

FIG. 7 is one embodiment of the highlight editing process once the highlight list 260 of FIG. 6 has been generated for a given program. In this embodiment, a user can interact with and customize the a resulting highlight program by providing commands to a highlight editor 710 using a user input device (e.g., remote control 730) and a graphical user interface (GUI) application 720. Initially, stream reader 750 is used to access highlight segments from the recorded content 220 and provide them to the GUI app 720. The particular segments to be accessed is set by the highlight editor 710, as shown in FIG. 7. Based on the previously-generated highlight list 260 and user input through the GUI App 720, the highlight editor 710 sends content location and window information to the stream reader 750 for accessing the highlight-containing portions of the recorded content 220. The stream reader 750 may then provide the selected highlight segments to the GUI App 720 which is then displayed on display 740. As the user views the highlight segments on the display 740, commands can be provided back to the highlight editor 710 to enlarge a highlight window, narrow a window, delete a highlight segment, add a highlight segment, etc. Once the user has completed customizing the highlight segments, a resulting highlight subprogram containing all of the final highlight segments may be separately stored on a local storage device (e.g., storage device 108). Alternatively, rather than storing the highlight subprogram separately, the stream reader 750 may generate the resulting highlight subprogram “on the fly” by successively accessing the defined highlight segments in the recorded content 220 and displaying them on display 740 as if it were a self-contained program. In one embodiment, the user may be able to pause, rewind, fast forward, etc. through the highlight subprogram, whether stored separately or generated on the fly.

Since the highlight list 260 is comprised of specific locations and descriptions, in order to capture the entire highlight, it is necessary to define a window around the highlight timestamp. This window may be highlight specific, user definable, or a combination of the two. In addition, the highlight editor 710 may contain a learning algorithm which adjusts the size of the highlight windows depending on user actions. By way of example, if a user consistently extends the highlight window of “score change” highlights, the highlight editor 710 may adjust the default window size for all “score change” highlights.

Referring now to FIG. 8, depicted is one embodiment of a GUI displayed on display 740 by GUI App 720 of FIG. 7. In this embodiment, GUI 800 includes a preview pane 810, a scene indicator 820, scene change options 830 and 840, lengthen and shorten options 850 and 860, and save option 870. Using a user-input device, such as remote control 730, a user select a particular scene or highlight using the scene change options 830 and 840. While navigating through the scene using normal rewind and fast forward options on the remote control device 730, a user can decide to lengthen or shorten a particular highlight using, for example, the lengthen and shorten buttons 850 and 860. Once the user is satisfied with the scene, the save option 870 may be selected. It should equally be appreciated that numerous other options and features may be included in GUI 800. For example, a user may be provided with options to delete a scene, change the order of scenes, add a scene, etc.

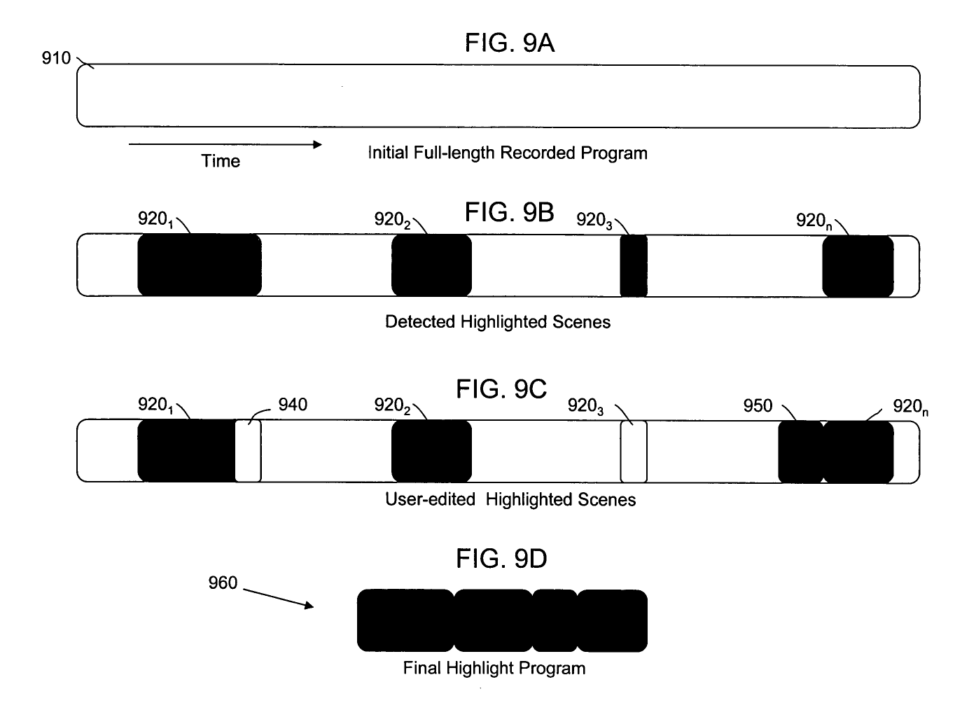

FIGS. 9A-9D depict conceptual diagrams of the highlight program creation process, according to one embodiment. In particular, program 910 of FIG. 9A represents the entire full-length recorded program. FIG. 9B depicts detected highlight segments 920₁-920ₙ. When a user first accesses the highlight editor, these segments 920₁-920ₙ may be presented for possible editing. In FIG. 9C a user has opted to make certain changes to the detected highlight segments 920₁-920ₙ. In particular, a user has chosen to shorten segment 920₁ by removing portion 940. The user has also decided to delete the entire segment 920₃. Finally, the user has extended highlight segment 920ₙ by expanding the window to include portion 950.

The end result of a user editing the originally detected highlight segments 920₁-920ₙ is shown in FIG. 9D. As previously mentioned, the resulting highlight program 960 may be stored separately on a local storage device (e.g., storage device 108) or, alternatively, may be generated on the fly by successively accessing the defined highlight segments in the full-length recorded program 910 and displaying them as if it were a self-contained program.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A method comprising:
receiving one or more user highlight parameters;
segmenting media content into video packets and closed-caption packets, wherein said video packets are comprised of a plurality of frames;
processing said video packets to identify graphical changes within a predetermined frame location between two or more of said plurality of frames, wherein said graphical changes are indicative of a potential highlight segment;
processing said closed-caption packets to identify highlight keywords that match at least one of said user highlight parameters; and
compiling a plurality of potential highlight segments into a highlight program based on at least one of said identified graphical changes and said identified highlight keywords.

2. The method of claim 1, wherein said video content is formatted as one of MPEG2, MPEG4 and Advanced Video Coding formats.

3. The method of claim 1, wherein said one or more user highlight parameters include one or more user-defined keywords.

4. The method of claim 1, wherein processing said video packets comprises comparing the predetermined frame locations of two or more of said plurality of frames, and wherein said graphical changes are based on said one or more user highlight parameters.

5. The method of claim 1, further comprising generating a video list based on said processing the video packets, wherein said video list contains highlight locations within said video content and corresponding descriptions.

6. The method of claim 5, further comprising generating a closed-caption list based on said processing the closed-caption packets, wherein said closed-caption list contains highlight locations within said video content and corresponding descriptions.

7. The method of claim 6, further comprising consolidating said video list and said closed-caption list into a highlight list containing highlight locations within said video content and corresponding descriptions.

8. The method of claim 7, further comprising accessing the plurality of potential highlight segments from said video content using said highlight list.

9. The method of claim 8, further comprising displaying said highlight program in an graphical user interface usable to edit said plurality of potential highlight segment.

10. The method of claim 1, further comprising editing said highlight program by altering one or more of said plurality of potential highlight segments

11. The method of claim 1, wherein processing said closed-caption packets comprises processing said closed-caption packets to identify highlight keywords that match at least one of said user highlight parameters and a default set of keywords.

12. The method of claim 1, further comprising segmenting said video content into video packets, closed-caption packets and audio packets.

13. An apparatus comprising:
a processor;
a storage device coupled to said processor; and
a memory containing instruction sequences to cause the processor to,
receive one or more user highlight parameters,
segment media content stored on said storage device into video packets and closed-caption packets, wherein said video packets are comprised of a plurality of frames,
process said video packets to identify graphical changes within a predetermined frame location between two or more of said plurality of frames, wherein said graphical changes are indicative of a potential highlight segment,
process said closed-caption packets to identify highlight keywords that match at least one of said user highlight parameters, and
compile a plurality of potential highlight segments into a highlight program based on at least one of said identified graphical changes and said identified highlight keywords.

14. The apparatus of claim 13, wherein said video content is formatted as one of MPEG2 and Advanced Video Coding.

15. The apparatus of claim 13, wherein said one or more user highlight parameters include one or more user-defined keywords.

16. The apparatus of claim 13, wherein said instructions sequences to cause the processor to process said video packets comprises instructions sequences to cause the processor to compare the predetermined frame locations of two or more of said plurality of frames, and wherein said graphical changes are based on said one or more user highlight parameters.

17. The apparatus of claim 1, wherein said instruction sequences further include instruction sequences to cause the processor to generate a video list based on said processing the video packets, wherein said video list contains highlight locations within said video content and corresponding descriptions.

18. The apparatus of claim 17, wherein said instruction sequences further include instruction sequences to cause the processor to generate a closed-caption list based on said processing the closed-caption packets, wherein said closed-caption list contains highlight locations within said video content and corresponding descriptions.

19. The apparatus of claim 18, wherein said instruction sequences further include instruction sequences to cause the processor to consolidate said video list and said closed-caption list into a highlight list containing highlight locations within said video content and corresponding descriptions.

20. The apparatus of claim 19, wherein said instruction sequences further include instruction sequences to cause the processor to access the plurality of potential highlight segments from said video content using said highlight list.

21. The apparatus of claim 20, wherein said apparatus is coupled to a display device, and wherein said instruction sequences further include instruction sequences to cause the processor to display said highlight program on said display in an graphical user interface usable to edit said plurality of potential highlight segment.

22. The apparatus of claim 1, wherein said instruction sequences further include instruction sequences to cause the processor to process one or more edit commands to edit said highlight program by altering one or more of said plurality of potential highlight segments.

23. The apparatus of claim 1, wherein said instructions sequences to cause the processor to process said closed-caption packets comprises instructions sequences to cause the processor to process said closed-caption packets to identify highlight keywords that match at least one of said user highlight parameters and a default set of keywords.

24. The apparatus of claim 1, wherein said instruction sequences further include instruction sequences to cause the processor to segment said video content into video packets, closed-caption packets and audio packets.

25. A computer program product comprising:
a computer usable medium having computer program code embodied therein, the computer program product having:
computer readable program code to receive one or more user highlight parameters;
computer readable program code to segment video content into video packets and closed-caption packets, wherein said video packets are comprised of a plurality of frames;
computer readable program code to process said video packets to identify graphical changes within a predetermined frame location between two or more of said plurality of frames, wherein said graphical changes are indicative of a potential highlight segment;
computer readable program code to process said closed-caption packets to identify highlight keywords that match at least one of said user highlight parameters; and
computer readable program code to compile a plurality of potential highlight segments into a highlight program based on at least one of said identified graphical changes and said identified highlight keywords.

26. The computer program product of claim 25, wherein said video content is formatted as one of MPEG2 and Advanced Video Coding.

27. The computer program product of claim 25, wherein said one or more user highlight parameters include one or more user-defined keywords.

28. The computer program product of claim 25, wherein said computer readable program code to process said video packets comprises computer readable program code to compare the predetermined frame locations of two or more of said plurality of frames, and wherein said graphical changes are based on said one or more user highlight parameters.

29. The computer program product of claim 25, further having computer readable program code to generate a video list based on the computer readable program code to process the video packets, wherein said video list contains highlight locations within said video content and corresponding descriptions.

30. The computer program product of claim 29, further having computer readable program code to generate a closed-caption list based on the computer readable program code to process the closed-caption packets, wherein said closed-caption list contains highlight locations within said video content and corresponding descriptions.

31. The computer program product of claim 30, further having computer readable program code to consolidate said video list and said closed-caption list into a highlight list containing highlight locations within said video content and corresponding descriptions.

32. The computer program product of claim 31, further having computer readable program code to access the plurality of potential highlight segments from said video content using said highlight list.

33. The computer program product of claim 32, further having computer readable program code to display said highlight program in an graphical user interface usable to edit said plurality of potential highlight segment.

34. The computer program product of claim 25, further having computer readable program code to receive edit commands to edit said highlight program by altering one or more of said plurality of potential highlight segments.

35. The computer program product of claim 25, wherein said computer readable program code to process said closed-caption packets comprises computer readable program code to process said closed-caption packets to identify highlight keywords that match at least one of said user highlight parameters and a default set of keywords.

36. The computer program product of claim 25, further having computer readable program code to segment said video content into video packets, closed-caption packets and audio packets.
